(19) United States
(12) Patent Application Publication
(10) Pub. No.: US 2010/0017709 A1
(43) Pub. Date: Jan. 21, 2010

(54) List display method and list display apparatus

(75) Inventors: Yoshitaka Wakai, Sendai (JP); Yuki Ogata, Sendai (JP); Toshiharu Kasai, Sendai (JP); Tsuyoshi Maita, Sendai (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/585,841

(22) Filed: Sep. 25, 2009

Related U.S. Application Data
(63) Continuation of application No. PCT/JP2007/056726, filed on Mar. 28, 2007.

(51) Int. Cl. G06F 17/21

(52) U.S. Cl. 715/273

(57) ABSTRACT

In a Web system that provides a social networking service in which information such as a diary and personal information is published on the Internet, upon displaying a list of articles of a diary or the like, if the number of the articles is equal to or less than a predetermined display number, a Web server creates a list that includes a subject of each article, and if the number of articles is larger than the predetermined display number, the Web server creates a list that includes categories in which the articles are categorized, and Web server then displays any of the lists thus created in a list display area of a Web browser provided in a user terminal.

### CROSS-REFERENCE TO RELATED APPLICATION(S)

This application is a continuation of PCT international application Ser. No. PCT/JP2007/056726 filed on Mar. 28, 2007 which designates the United States, the entire contents of which are incorporated herein by reference.

### FIELD

The embodiments discussed herein are directed to a list display method and a list display apparatus by which a list of articles is displayed in a predetermined display area of a display device.

### BACKGROUND

In recent years, the number of people using a social networking service (SNS) is rapidly increasing in which each user publishes a diary and personal information on the Internet. Most of such SNSs are membership services. A user who is registered as a member of an SNS logs in to a website of the SNS, and therein can browse articles in which diaries and personal information of other members are published.

Typically in an SNS website, each user is provided with a personal page in which each user can write a diary or edit a personal profile. Some of such personal pages have a function by which a list of articles (such as What's New articles) is depicted in a predetermined display area in the personal page. Such a list display function is useful, for example, in checking the articles newly added to the SNS.

The number of articles in such a list, however, increases as the number of the members increases, and in some cases, the display area in the page is too small for displaying all the articles. In such cases, the list of the articles is displayed on a plurality of pages on end, and a user is required to check the articles while operating a scroll bar or a page moving button. Thus, the articles cannot be conveniently browsed.

Various methods have been proposed in which a list is efficiently displayed depending on the number of the articles that are to be displayed in the page. For example, in Japanese Laid-open Patent Publication No. 2001-306618, a method is disclosed in which documents managed according to categories are displayed. More specifically, if the number of the documents included in a category specified by a user is equal to or more than a first reference value, a list is displayed of the documents included in the category specified by the user, and if the number of the documents is equal to or less than a second reference value, a list is displayed of the documents included in the category specified by the user and of the documents included in other categories.

Japanese Laid-open Patent Publication No. 2003-271664 discloses a method in which contents such as electronic books are displayed. More specifically, if the number of the contents that are displayed is less than a predetermined reference value, a title of each content is displayed by using a bigger icon, and if the number of the contents that are displayed is equal to or more than the predetermined reference value, a title of each content is displayed by using a smaller icon.

Japanese Laid-open Patent Publication No. 06-19977 discloses a method in which phrases that are searched for in an electronic dictionary are displayed. More specifically, if the number of the phrases that are searched for is more than a predetermined reference value, a list of the phrases is displayed, and if the number of the phrases that are searched for is equal to or less than the predetermined reference value, not a list of the phrases but entire information of the phrases is displayed in a display area.

Even according to the conventional technologies, however, if the number of the items that are displayed in the display area is larger than the number of the items that can be displayed therein, a list of the information that is displayed therein is displayed in a plurality of pages on end. As a result, a problem that a user cannot conveniently read the list remains yet to be solved.

It is expected that more and more people use SNS as new means for person-to-person communication in the society of the Internet society, and thus, a need for a user-friendly service having an excellent usability has been demanded. Therefore, to provide a method in which a user can conveniently browse articles by using a list displayed in a display area is an issue of great significance.

### SUMMARY

According to an aspect of the invention, a list display method in which a computer displays a list of articles in a predetermined display area of a display device, includes creating a list of subjects of the articles if the number of articles is equal to or less than a predetermined display number, and creating a list of categories in which the articles are categorized if the number of articles is larger than the display number; and displaying the created list in the display area.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a concept of a list display method according to a first embodiment of the present invention;

FIG. 2 is a functional block diagram of a configuration of a Web system according to the first embodiment;

FIG. 3 depicts an example of a member information table depicted in FIG. 2;

FIG. 4 depicts an example of a category information table depicted in FIG. 2;

FIG. 5 depicts an example of an article information table depicted in FIG. 2;

FIG. 6 depicts an example of article information;

FIG. 7 depicts an example of a folder list created based on article creation dates and times;

FIG. 8 depicts an example of a folder list created based on category information;

FIGS. 9A and 9B illustrate abbreviation of article subjects;

FIG. 10 is a flowchart of procedures performed by the Web system depicted in FIG. 2;

FIG. 11 is a flowchart of procedures performed by a reference value calculating process depicted in FIG. 10;

FIG. 12 is a flowchart of procedures performed by a subject list creating process depicted in FIG. 10;

FIG. 13 is a flowchart of procedures performed by a folder list creating process depicted in FIG. 10;

FIG. 14 illustrates hierarchical display of folders;

FIG. 15 depicts an example of a keyword association table that is used to automatically create a category;

FIG. 16 illustrates automatic creation of a category; and

FIG. 17 is a functional block diagram of a configuration of a computer that executes a list display computer program.

### DESCRIPTION OF EMBODIMENTS

Preferred embodiments of the present invention will be explained with reference to accompanying drawings. In the embodiments below, examples are described in which the present invention is applied to a Web system that provides SNS. The present invention is not limited to the embodiments.

### [a] First Embodiment

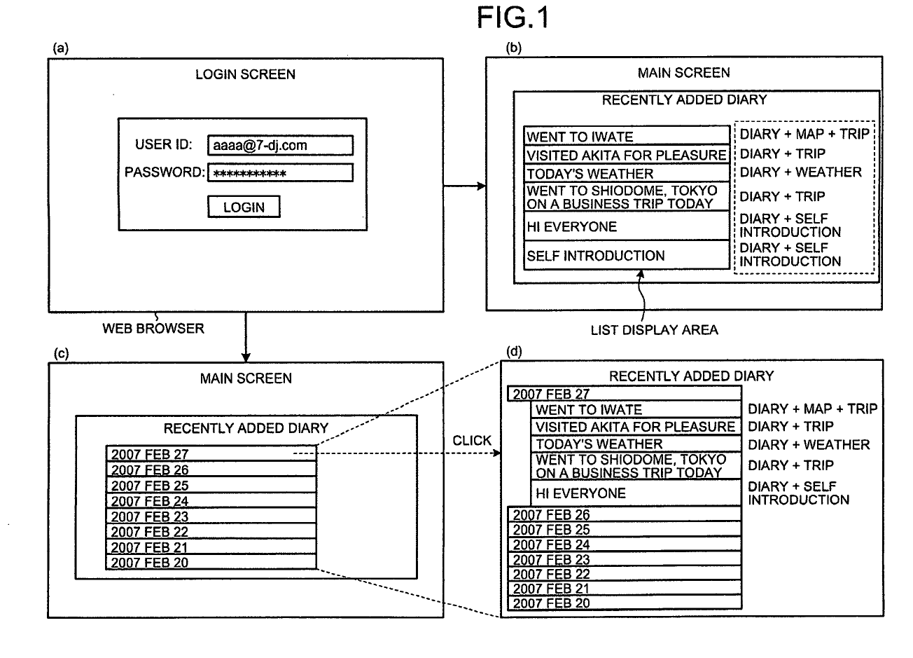

A concept of a list display method according to a first embodiment of the present invention is described below. FIG. 1 illustrates a concept of the list display method according to the first embodiment. The list display method is employed to display a list of articles such as a diary in a predetermined display area of a Web browser provided in a user terminal used by a user.

In the list display method according to the first embodiment, if the number of articles is equal to or less than a predetermined display number, a list that includes a subject of each article is created, and if the number of articles is larger than the predetermined display number, a list that includes categories in which the articles are categorized is created. Then, a list thus created either of the subjects or the categories is displayed in the predetermined display area of the Web browser provided in the user terminal.

More specifically, a Web system first displays a login screen in the Web browser of the user terminal as depicted in (a) of FIG. 1 in response to a request from the user. When the user inputs a user ID and a password thereof in the login screen, user authentification is performed. Then, a list of the recently added articles created by the other users within the most recent week is displayed in a predetermined list display area in a main screen. In the first example, eight articles can be displayed in the list display area.

If the number of the recently added articles is equal to or less than a predetermined number of the articles that can be displayed in the list display area, the Web system creates a list of a subject of each article, and then, displays the list in the list display area in the main screen. For example, if the number of the recently added articles is equal to or less than eight (in FIG. 1, there are six articles), the Web system creates a list that includes a subject of each article as depicted in (b) of FIG. 1, and then, displays the list in the list display area in the main screen.

On the other hand, if the number of the recently added articles is larger than the predetermined number of the articles that can be displayed in the list display area, the Web system creates a list of folders of which each corresponds to each category in which the articles are categorized, and then, displays the list in the predetermined display area in the main screen. For example, if the number of the recently added articles is equal to or larger than nine, the Web system creates as many date folders as a predetermined number of days as depicted in (c) of FIG. 1, and then, displays the date folders in the list display area in the main screen.

When the user selects a folder in the folder list, the Web system displays the subject of each article created on the date corresponding to the folder under the selected folder, as depicted in (d) of FIG. 1.

Thus, in the list display method according to the first embodiment, the Web system creates a list of the recently added articles depending on the number of the recently added articles so that the articles can be displayed within the list display area. Thus, the articles can be conveniently browsed in the list.

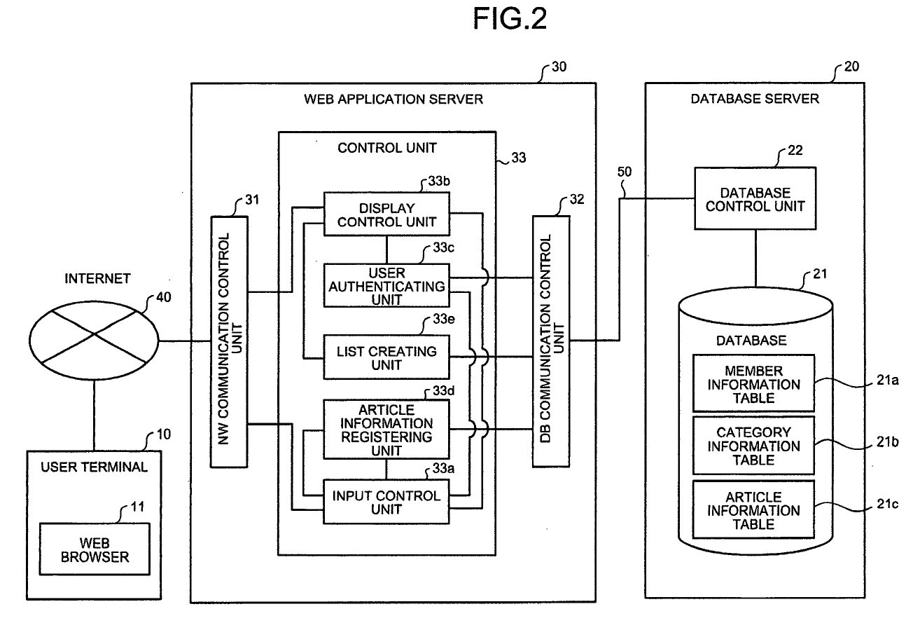

A configuration of the Web system according to the first embodiment is described below. FIG. 2 is a functional block diagram of a configuration of the Web system according to the first embodiment. As depicted in FIG. 2, the Web system includes a user terminal 10, a database server 20, and a Web application server 30. The user terminal 10 and the Web application server 30 are connected to each other via the Internet 40. The database server 20 and the Web application server 30 are connected to each other via a network 50.

The user terminal 10 is a data processing terminal such as a computer used by the user. The user terminal 10 displays therein information transmitted by various other Web services, and includes a Web browser 11 that accepts various requests from the user.

The database server 20 is a server that stores therein various data, and includes a database 21 and a database control unit 22.

The database 21 is a storage unit that stores therein data required for an SNS service provided by the Web application server 30. The database 21 stores therein a member information table 21a, a category information table 21b, and an article information table 21c.

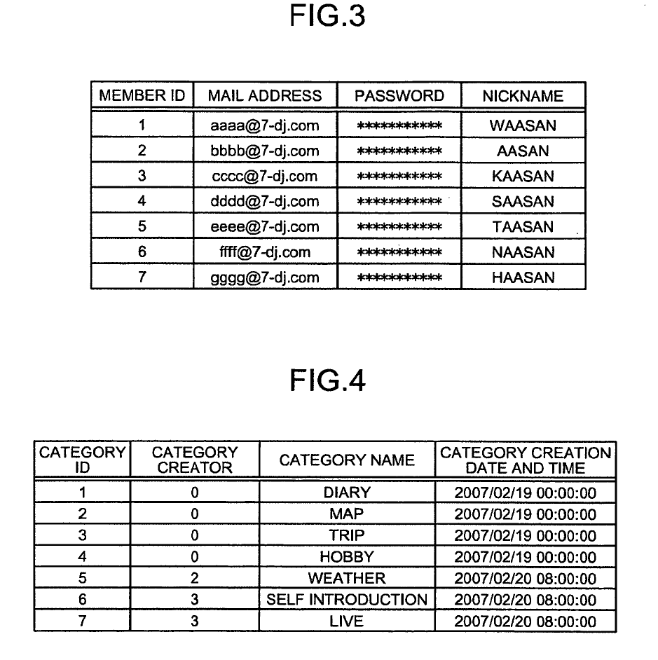

The member information table 21a is a table in which user information of each user registered in the SNS service provided by the Web application server 30 is stored. FIG. 3 depicts an example of the member information table 21a. More specifically, the member information table 21a stores therein member information for each user in which a “mail address”, a “password”, and a “nickname” that are registered by each user are associated with a “member ID” that is uniquely assigned to each user, as depicted in FIG. 3. The mail address and the password, among the mail address, the password, the nickname, and the member ID, correspond respectively to the user ID and the password that the user inputs in the login screen during login.

The category information table 21b is a table in which category information in which various categories that are used for categorizing articles such as a diary are defined is stored. FIG. 4 depicts an example of the category information table 21b. More specifically, the category information table 21b stores therein category information for each category in which a “category ID” that is uniquely assigned to each category, a “category creator” that is the member ID of the user that creates each category, a “category name” that is the name of each category displayed in the folder list and the like, and a “category creation date and time” that denotes the date and the time when the category information is created are associated with each other, as depicted in FIG. 4.

The category information may be registered by, for example, a system administrator in advance, or may be arbitrarily registered by a user when the user writes an article such as a diary. For example, the category information in which “0” is assigned to the category creator as depicted in FIG. 4 is registered by the system administrator in advance.

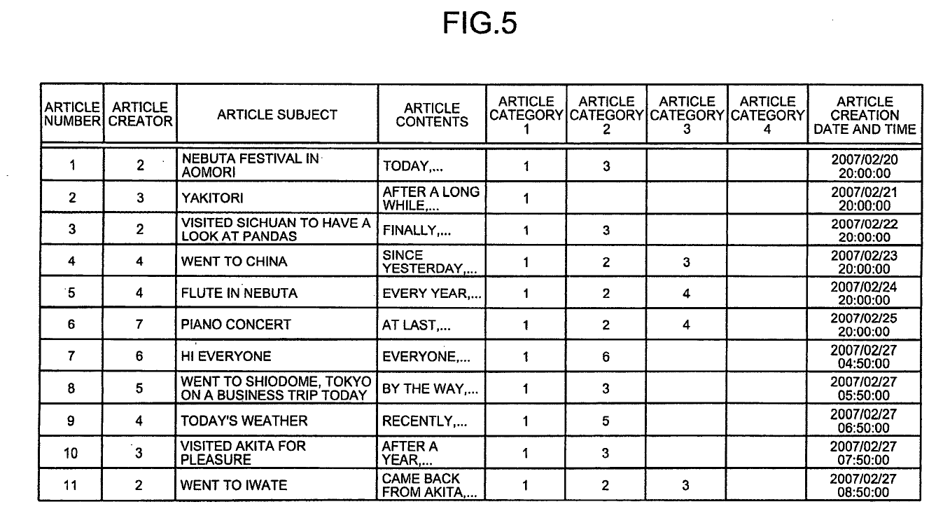

The article information table 21c is a table that stores therein article information including articles such as a diary. FIG. 5 depicts an example of the article information table 21c. More specifically, the article information table 21c stores therein category information for each article in which an “article number” that is uniquely assigned to each article, an “article creator” that is the member ID of the user that creates each article, an “article subject” that is the subject (title) of each article assigned by the user, “article contents” that are the body of each article registered by the user, the categories in which each article is categorized that are “article category 1”, “article category 2”, “article category 3”, and “article category 4”, and “article creation date and time” that denotes the date and the time when the user creates each article are associated with each other, as depicted in FIG. 5.

The article information is created by the user by using the main screen displayed in the Web browser 11 in the user terminal 10 by the Web application server 30 that is described later. The article categories 1 to 4 may be registered by the Web application server 30 or may be arbitrarily registered by the user when the user creates each article.

The database control unit 22 is a processing unit that obtains data from each table stored in the database 21 following a request from the Web application server 30, and responds with the data thus obtained to the Web application server 30.

The Web application server 30 is a server that provides an SNS service, and includes an NW communication control unit 31, a DB communication control unit 32, and a control unit 33.

The NW communication control unit 31 is a processing unit that controls sending and receiving of various data to and from the user terminal 10 via the Internet 40. The DB communication control unit 32 is a processing unit that controls sending and receiving of various data to and from the database server 20.

The control unit 33 is a control unit that performs overall control of the Web application server 30. The control unit 33 includes, as conceptual functioning units, an input control unit 33a, a display control unit 33b, a user authenticating unit 33c, an article information registering unit 33d, and a list creating unit 33e.

The input control unit 33a is a processing unit that receives various pieces of information transmitted by the user terminal 10 via the NW communication control unit 31 and that transfers the information thus received to a proper processing unit. For example, if the input control unit 33a receives an access request for the login screen, the input control unit 33a transfers the access request to the display control unit 33b. If the input control unit 33a receives login information, the input control unit 33a transfers the login information to the user authenticating unit 33c.

If the input control unit 33a receives selection of a folder or an article, the input control unit 33a transfers information in which the folder or the article thus selected is specified to the display control unit 33b. If the input control unit 33a receives article information input by the user, the input control unit 33a transfers information about the article that is input thereby to the article information registering unit 33d.

The display control unit 33b receives information transferred by each processing unit, and creates, based on the information thus received, screen control information to display various screens in the Web browser 11 in the user terminal 10. Then, the display control unit 33b transmits the screen control information to the user terminal 10 via the NW communication control unit 31.

For example, if an access request for the login screen is transferred to the display control unit 33b by the input control unit 33a, the display control unit 33b creates screen control information to display the login screen in the Web browser 11, and then, transmits the screen control information to the user terminal 10. If the user authenticating unit 33c instructs the display control unit 33b to display the main screen in the Web browser 11, the display control unit 33b instructs to create a list of What's New information and creates screen control information to display the list thus created in the main screen set in the display area. Then, the display control unit 33b transmits the screen control information to the user terminal 10.

If the information according to which a folder selected by the user is specified is transferred from the input control unit 33a to the display control unit 33b, the display control unit 33b instructs to create a list of subjects of the articles that are categorized in the category of the folder. Then, the display control unit 33b creates screen control information to display the list thus created in the main screen set in the display area. Thus, the display control unit 33b transmits the screen control information to the user terminal 10.

If the information according to which an article selected by the user is specified is transferred from the input control unit 33a to the display control unit 33b, the display control unit 33b obtains article information corresponding to the article from article information stored in an internal memory of the list creating unit 33e by the list creating unit 33e that is described later, and creates screen control information to display the article information thus obtained in the display area, and then, transmits the screen control information to the user terminal 10.

The user authenticating unit 33c requests from the database server 20 via the DB communication control unit 32 member information corresponding to the user ID and the password included in the login information transmitted by the user terminal 10, and then, performs user authentication according to the result of the response from the database server 20. If the database server 20 responds with member information to the user authenticating unit 33c, the user authenticating unit 33c determines that the user ID and the password transmitted by the user terminal 10 belong to an official user registered as a member thereof, and instructs the display control unit 33b to display the main screen in the Web browser 11.

The article information registering unit 33d transmits article information such as a diary transmitted from the user terminal 10 to the database server 20 via the DB communication control unit 32.

The list creating unit 33e obtains article information from the database server 20 via the DB communication control unit 32 following a request from the display control unit 33b, and creates a subject list or a folder list of the articles according to the article information thus obtained.

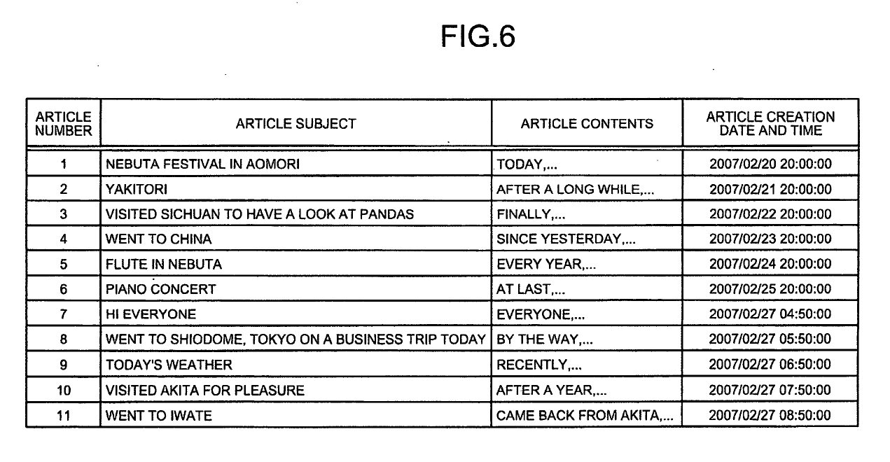

More specifically, if the display control unit 33b instructs the list creating unit 33e to create a list of What's New information, the list creating unit 33e first obtains article information created within the most recent week from the database server 20 via the DB communication control unit 32, and then, and stores the article information in the internal memory after extracting necessary items from the article information. FIG. 6 depicts an example of the article information. As depicted in FIG. 6, the list creating unit 33e stores in the internal memory the article information containing of the article number, the article subject, the article contents, and the article creation date and time.

Then, the list creating unit 33e obtains the screen size and the font size of the Web browser 11 from browser information included in the login information transmitted from the user terminal 10. Then, the list creating unit 33e calculates the number of the articles (lines) that can be displayed in list display area in the Web browser 11 and the number of the characters that can be displayed in each line, based on the screen size and the font size that are thus obtained. The “number of the lines” and the “number of the characters” that can be thus calculated are respectively referred to as the “reference number of the items” and the “reference number of the characters”.

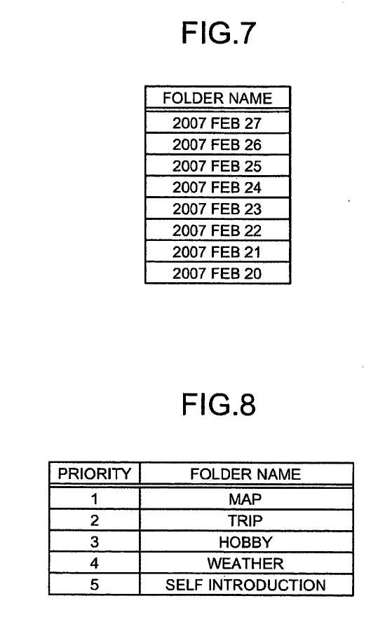

The list creating unit 33e creates a list of a subject of each piece of article information if the number of the pieces of the article information obtained from the database server 20 is equal to or less than the reference number of the items. The list creating unit 33e creates as many folders as the number of predetermined dates if the number of the pieces of the article information is larger than the number of the reference number of the items. For example, if the list creating unit 33e displays What's New information for a week, the list creating unit 33e creates eight folders. FIG. 7 depicts an example of a folder list created according to the article creation date and time. As depicted in FIG. 7, the list creating unit 33e creates a folder list in which folders are arranged in the descending order of the date.

Thus, the list creating unit 33e obtains the size of the list display area from the browser information, calculates the reference number of the items based on the size of the list display area, and the list creating unit 33e creates a list of the subject of each article if the number of the articles is equal to or less than the reference number of the items thus calculated. If the number of the articles is larger than the reference number of the items thus calculated, a list of the categories in which each article is categorized is created. Therefore, even if the number of the items that can be displayed in the list display area may fluctuate depending on a setup of the user terminal 10, the number of the lines and the number of the characters can be automatically modified according to the size of the list display area. As a result, the articles can be conveniently be browsed in the list.

Here, an example is described in which a date is used as a category and a folder is created for each date. Creation of a folder is not limited thereto. For example, category information may be obtained from the database server 20, and a folder list may be created based on the category information thus obtained. FIG. 8 depicts an example of a folder list created based on the category information. Then, for example, the list creating unit 33e assigns a priority to each category based on information such as usage frequency thereof, as depicted in FIG. 8, and creates a folder list that includes the categories (folders) arranged in the order of the priorities.

If a folder list that includes as many dates as the predetermined number is created, a date on which any article is not updated may be included therein. If a folder list is created based on the category information, a category that does not include any article created within the most recent week may be present in the folder list. Then, the list creating unit 33e deletes such a folder of a category that does not include any article. Thus, a category that is unnecessary in browsing the articles can be prevented from being included in the list. Then, the articles can be conveniently browsed in the list.

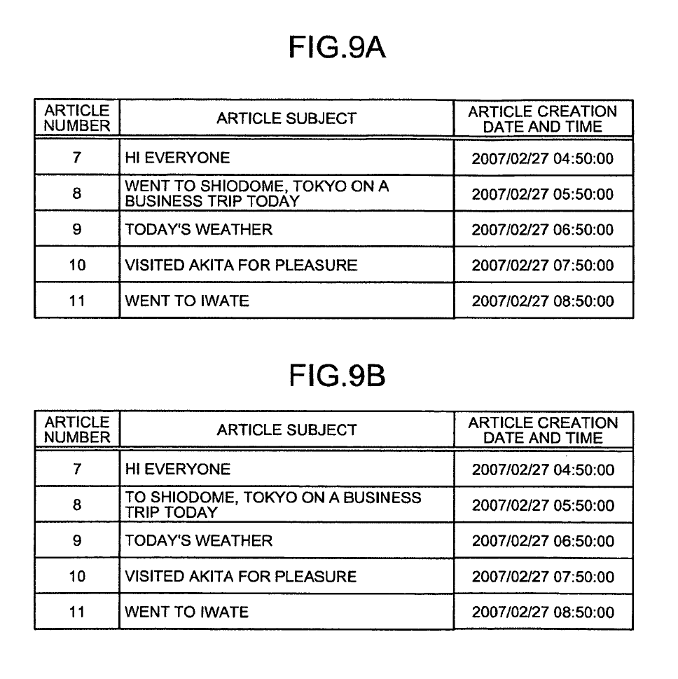

If the list creating unit 33e creates a subject list based on the article information obtained from the database server 20, an article of which the number of the characters of the subject is larger than the reference number of the characters may be included in the subject list. Then, such an article subject is abbreviated. FIGS. 9A and 9B illustrate abbreviation of an article subject. For example, if an article subject is created from the article information depicted in FIG. 9A, the characters more than the reference number of the characters included in the article subject are abbreviated so that the number of the characters included in an abbreviated article subject is equal to or less than the reference number of the characters as depicted in FIG. 9B. Thus, the number of characters included in each subject can be automatically set to be the same depending on the number of the characters that can be displayed in each line within the list display area.

The main processes performed by the list creating unit 33e have been described. Procedures performed by the list creating unit 33e, however, are described later in detail.

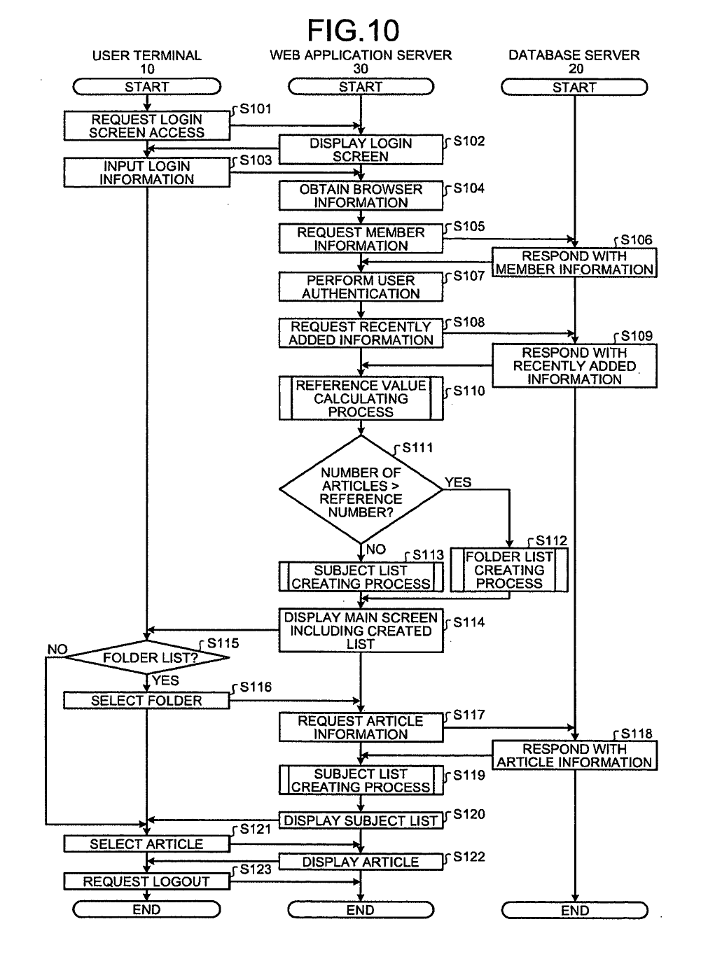

Procedures performed by the Web system according to the first embodiment are described below in detail. FIG. 10 is a flowchart of procedures performed by the Web system according to the first embodiment. As depicted in FIG. 10, in the Web system, if the user terminal 10 transmits a login screen access request to the Web application server 30 following an instruction from the user (Step S101), the Web application server 30 that receives the access request transmits to the user terminal 10 screen control information to display the login screen (Step S102).

The user terminal 10 displays the login screen in the Web browser 11 by using the information transmitted by the Web application server 30. The user inputs login information in the login screen. Then, the login information that is input by the user is transmitted to the Web application server 30 (Step S103).

When the Web application server 30 receives the login information, the Web application server 30 obtains the browser information included in the login information, and stores the browser information in the internal memory (Step S104).

Then, the Web application server 30 requests from the database server 20 member information corresponding to the user ID and the password included in the login information received from the user terminal 10 (Step S105).

When the Web application server 30 requests the member information from the database server 20, the database server 20 obtains the member information from the member information table 21a, and then, responds with the member information to the Web application server 30 (Step S106). If the member information that is requested by the Web application server 30 is not registered in the member information table 21a, the database server 20 responds with information in which obtaining error is depicted to the Web application server 30.

If the Web application server 30 receives the member information responded by the database server 20, the Web application server 30 performs a user authenticating process (Step S107). More specifically, if the database server 20 responds with the member information to the Web application server 30, the Web application server 30 determines that the user ID and the password transmitted by the user terminal 10 belong to an official user registered as a member. On the other hand, if the database server 20 responds with the obtaining error thereto, the Web application server 30 transmits to the user terminal 10 screen control information to display in the Web browser 11 a message indicating that the user ID or the password is not registered therein (not depicted).

If the user ID and the password are confirmed to belong to an official user, the Web application server 30 requests from the database server 20 recently added article information that is created within the most recent week (Step S108).

When the Web application server 30 requests from the database server 20 recently added article information, the database server 20 obtains the article information from the article information table 21c, and then, responds with the article information to the Web application server 30 (Step S109).

When the Web application server 30 receives the recently added article information from the database server 20, the Web application server 30 stores the article information thus received in the internal memory and performs a reference value calculating process in which a reference number of the characters and a reference number of the items can be calculated (Step S110). Procedures performed by the reference value calculating process are described later in detail.

If the number of the pieces of the recently added article information responded from the database server 20 is larger than the reference number of the items calculated in the reference value calculating process (YES at Step S111), the Web application server 30 performs a folder list creating process in which a folder list is created (Step S112). Conversely, the number of the pieces of the recently added article information is equal to or less than the reference number of the items (NO at Step S111), the Web application server 30 performs a subject list creating process in which a subject list is created (Step S113). Procedures performed by the folder list creating process and the subject list creating process are described later in detail.

The Web application server 30 creates the folder list or the subject list, and then, the Web application server 30 transmits to the user terminal 10 screen control information to display the main screen with the list thus created displayed in the list display area (Step S114).

When the user terminal 10 receives the information, the user terminal 10 displays the main screen in the Web browser 11. If the list set in the list display area in the main screen is a folder list (YES at Step S115), the user terminal 10 transmits to the Web application server 30 information in which a folder selected by the user is specified when the user selects the folder (Step S116).

If the list set in the list display area in the main screen is a subject list (NO at Step S115), the user terminal 10 waits for the user to select an article in the subject list.

When the Web application server 30 receives the information indicating the folder selected by the user, the Web application server 30 requests from the database server 20 the article information categorized in the category of the folder (Step S117).

When the Web application server 30 requests from the database server 20 the article information, the database server 20 obtains the requested article information from the article information table 21c, and then, responds with the article information to the Web application server 30 (Step S118).

When the Web application server 30 receives the article information from the database server 20, the Web application server 30 stores the article information in the internal memory and performs a subject list creating process in which a subject list is created (Step S119), and then, transmits to the user terminal 10 screen control information to display the subject list thus created in the main screen (Step S120).

When the user terminal 10 receives the screen control information, the user terminal 10 displays the subject list in the main screen based on the screen control information, and waits for the user to select an article in the subject list.

When the user selects an article in the subject list, the user terminal 10 transmits to the Web application server 30 information indicating the article selected by the user (Step S121).

When the user terminal 10 transmits to the Web application server 30 the information indicating the article selected by the user, the Web application server 30 obtains the article information based on the information from the article information stored in the internal memory, and then, transmits to the user terminal 10 screen control information to display the article information thus obtained in the list display area (Step S122).

Then, when the user requests logout, the user terminal 10 transmits a logout request to the Web application server 30 (Step S123), and when the Web application server 30 receives the logout request, the Web application server 30 terminates providing service to the user.

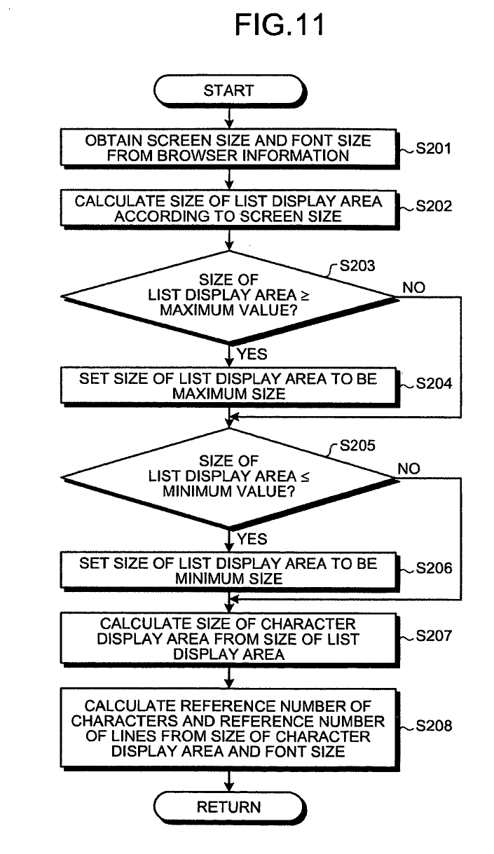

Procedures performed by a reference value calculating process depicted in FIG. 10 are described below in detail. FIG. 11 is a flowchart of procedures performed by the reference value calculating process depicted in FIG. 10. The reference value calculating process is performed by the list creating unit 33e in the Web application server 30.

As depicted in FIG. 11, the list creating unit 33e obtains from the browser information stored in the internal memory the screen sizes (both vertical and horizontal) and the font size (Step S201), and then, calculates the size of the list display area according to the screen sizes thus obtained (Step S202). More specifically, the list creating unit 33e calculates the size of the list display area by multiplying the screen sizes thus obtained by a size ratio of the list display area with respect to the screen sizes (for example, horizontally 0.2 and vertically 0.25).

The list creating unit 33e determines whether the size of the list display area thus calculated is equal to or larger than a predetermined maximum size (for example, horizontally 200 and vertically 200). If the size thereof is equal to or larger than the predetermined maximum size (YES at Step S203), the size of the list display area is set to be the predetermined maximum size (Step S204). Conversely, if the size thereof is smaller than the predetermined maximum size (NO at Step S203), the size of the list display area thus calculated is set to be the size thereof.

Then, the list creating unit 33e determines whether the size decided to be the size of the list display area is equal to or smaller than a predetermined minimum size (for example, horizontally 100 and vertically 100). If the size thereof is equal to or smaller than the predetermined minimum size (YES at Step S205), the size of the list display area is set to be the predetermined minimum size (Step S206). Conversely, if the size thereof is larger than the predetermined minimum size (NO at Step S205), the size of the list display area thus calculated is set to be the size thereof.

The list creating unit 33e calculates the size of a character display area in which characters are actually displayed, from the size of the list display area thus decided above (Step S207). More specifically, the list creating unit 33e calculates the size of the character display area by multiplying the size of the list display area by a size ratio of the character display area with respect to the list display area (for example, horizontally 0.85 and vertically 0.75).

The list creating unit 33e performs the size calculation above for each horizontal size and vertical size. The list creating unit 33e calculates the reference number of the characters and the reference number of the items, from the size of the character display area thus calculated and to the font size obtained from the browser information (Step S208). More specifically, the list creating unit 33e calculates the reference number of the characters by diving the horizontal size of the character display area by the font width, and calculates the reference number of the items by dividing the vertical size of the character display area by the font height.

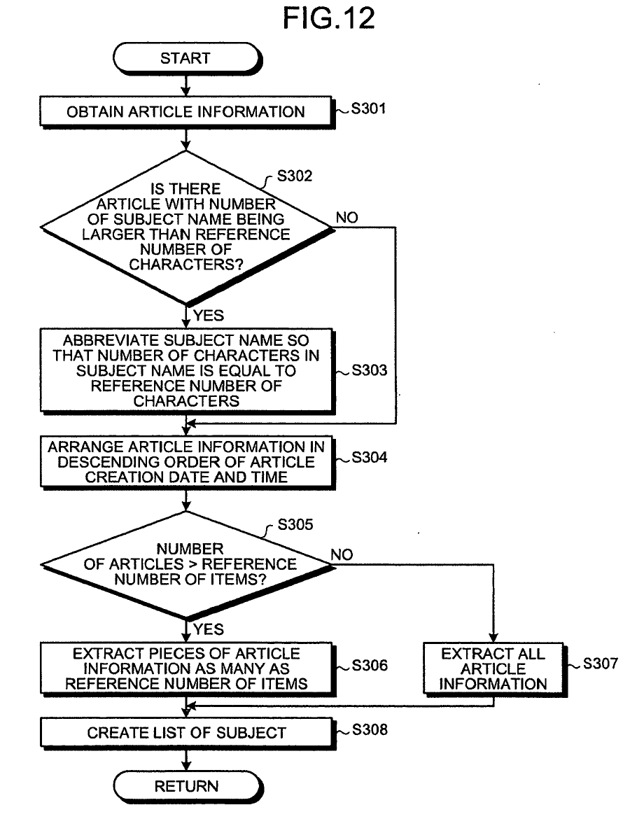

Procedures performed by the subject list creating process depicted in FIG. 10 are described below in detail. FIG. 12 is a flowchart of procedures performed by the subject list creating process depicted in FIG. 10. The subject list creating process is also performed by the list creating unit 33e in the Web application server 30.

The list creating unit 33e obtains the article information stored in the internal memory (Step S301), and determines whether there is a piece of article information with the number of the characters of the article subject being larger than the reference number of the characters in the article information included in the obtained article information.

If there is a piece of article information with the number of the characters of the article subject being larger than the reference number of the characters (YES at Step S302), the list creating unit 33e abbreviates the characters of the article subject of the piece of article information so that the number of the characters of the article subject is equal to the reference number of the characters (Step S303). Conversely, if there is no piece of article information with the number of the characters of the article subject being equal to or smaller than the reference number of the characters (NO at Step S302), the list creating unit 33e does not abbreviate the characters of the article subject, and the system control is given to Step S304.

The list creating unit 33e arranges the pieces of the article information in the descending order of the article creation date and time (Step S304), and determines whether the number of the pieces of the article information is larger than the reference number of the items. If the number of the pieces of the article information is larger than the reference number of the items (YES at Step S305), the list creating unit 33e extracts therefrom as many pieces of the article information as the reference number of the items (Step S306). Conversely, if the number of the pieces of the article information is equal to or smaller than the reference number of the items (NO at Step S305), the list creating unit 33e extracts all the pieces of the article information therefrom (Step S307).

The list creating unit 33e creates a subject list based on the article subjects of the extracted pieces of the article information (Step S308).

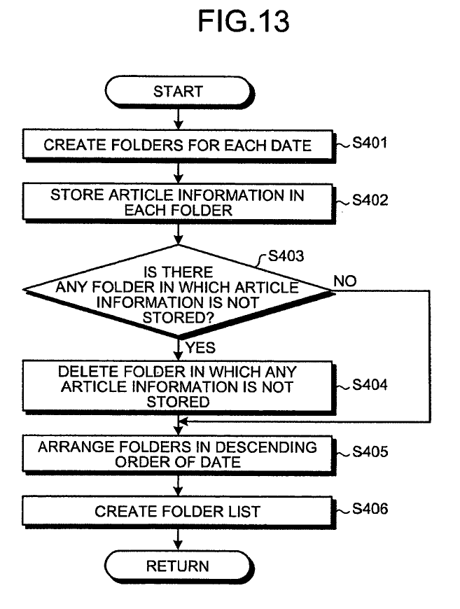

Procedures performed by the folder list creating process depicted in FIG. 10 are described below in detail. FIG. 13 is a flowchart of procedures performed by the folder list creating process depicted in FIG. 10. The folder list creating process is also performed by the list creating unit 33e in the Web application server 30. Here, an example is described in which a folder list of the date is created.

The list creating unit 33e creates a folder for each date so that the number of the folders is the same as a predetermined number of dates (Step S401), and distributes and stores articles in the folders thus created corresponding to the article creation date (Step S402).

The list creating unit 33e determines whether there is a folder in which article information is not stored among the folders thus created. If there is a folder in which article information is not stored (YES at Step S403), the list creating unit 33e deletes the folder (Step S404). Conversely, if there is no folder in which article information is not stored (NO at Step S403), the list creating unit 33e does not delete any folder, and the system control is given to Step S405.

The list creating unit 33e arranges in the descending order the folders of the date thus created (Step S405), and then, creates a folder list (Step S406).

As described above, according to the first embodiment, in the Web application server 30, if the number of the articles is equal to or less than the reference number of the items, the list creating unit 33e creates a subject list of the articles. If the number of the articles is larger than the reference number of the items, the list creating unit 33e creates a list of the categories in which the articles are categorized. Then, the display control unit 33b displays the list created by the list creating unit 33e in the list display area in the main screen. Therefore a list of the articles can be displayed so that the list is displayed within the list display area. As a result, the articles can be more conveniently browsed according to the list.

### [b] Second Embodiment

The present invention may be implemented in various other embodiments other than the first embodiment described above. Thus, another embodiment of the present invention is described as a second embodiment of the present invention.

(1) Hierarchical Display of Folders

In the first embodiment above, an example is described in which when the user selects a folder in the folder list after the folder list is displayed in the Web browser 11 in the user terminal 10. Then, the list creating unit 33e creates a subject list of the articles categorized in the category of the selected folder, and then, the list is displayed in the list display area of the main screen. The present invention is, however, not limited thereto.

For example, the user may select a folder in the list, and the number of the articles therein is larger than a predetermined number of the articles that can be displayed. Then, the list creating unit 33e may create a list of subordinate categories in which the articles can be categorized, and thus, the categories may be displayed in hierarchical manner.

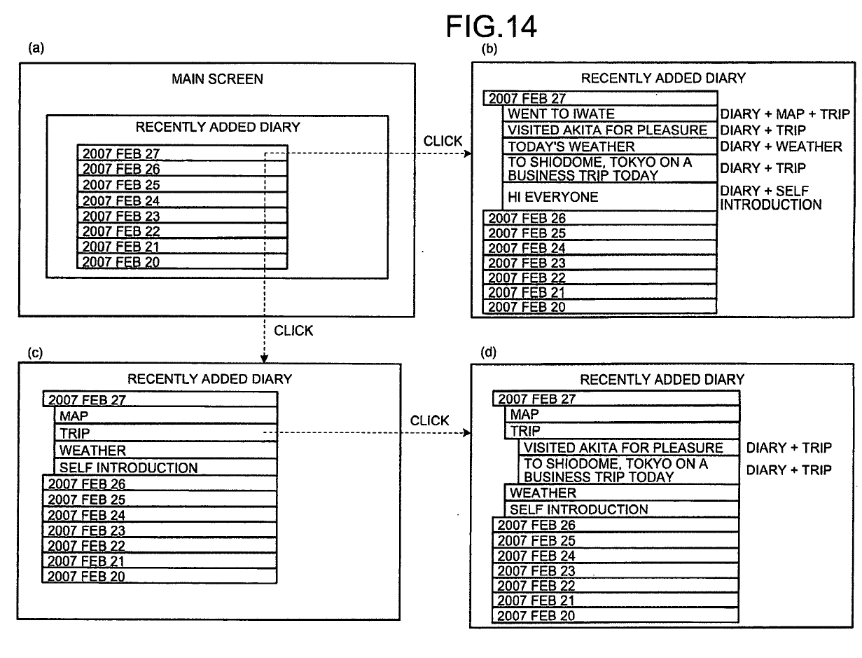

Hierarchical display of the folders is described below in detail. FIG. 14 illustrates hierarchical display of folders. For example, when a folder list is displayed as depicted in (a) of FIG. 14, the user may select a folder in the list. If the number of the articles that belong to the category of the selected folder is equal to or less than a predetermined number of the articles that can be displayed, the list creating unit 33e creates and displays a subject list as depicted in (b) of FIG. 14.

On the other hand, if the number of the articles therein is larger than the predetermined number of the articles that can be displayed, the list creating unit 33e obtains article information corresponding to the articles that belong to the category of the selected folder from the article information table 21c. The list creating unit 33e creates a list of subordinate folders by using, as subordinate categories, the rest of the categories in the article categories 1 to 4 of the article information other than the categories already used for creating the folders. Then, the subordinate folders are displayed under the selected folder, as depicted in (c) of FIG. 14.

If the user selects a folder among the folders included in the subordinate folder list, the list creating unit 33e displays, as depicted in (d) of FIG. 14, the subjects of the articles whose article creation date matches the date of the folder, under the selected folder.

Thus, if the user selects a folder in the list of the displayed folders, the number of the articles that belong to the category of the selected folder may be larger than the predetermined number of the articles that can be displayed. Then, a list of the folders is displayed, instead of a list of the articles. Therefore, the number of the articles included in the list in a hierarchical manner can be modified according to the size of the list display area. As a result, the articles can be more conveniently browsed according to the list.

In the embodiment above, a folder is created by using the categories associated with the article information. The types of the categories can, however, be arbitrarily registered by the user. Therefore, unless the Web system provides some limitation thereon, the types of the categories may be increased unlimitedly. If the types of the categories increase significantly, the effect of the present invention may be reduced that the number of the articles that are displayed can be reduced by summarizing the articles according to the categories. Particularly in a Web system that is used worldwide, a problem that the effect of the invention is reduced is expected to be significant.

Therefore, in a Web system, a certain process may be adapted by which the categories do not increase in number unlimitedly, for example, by setting a maximum value in the number of the categories that can be registered for each user, or by periodically deleting the categories that are less frequently used.

(2) Automatic Creation of a Category

In the first embodiment above, an example is described in which a folder is created based on fixed attribute information such as a predetermined number of days or category information stored in the category information table 21b. The present invention is, however, not limited thereto.

For example, if the number of the categories is larger than a predetermined number of the articles that can be displayed when the list creating unit 33e creates a folder list corresponding to the categories, the list creating unit 33e may automatically create a new higher category in which a plurality of categories can be summarized, and thus, the category list can be summarized according to the size of the list display area.

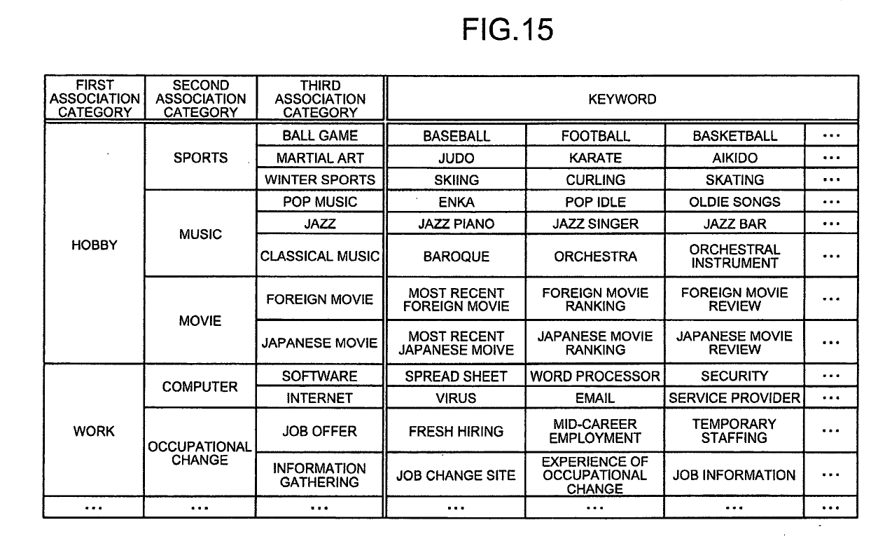

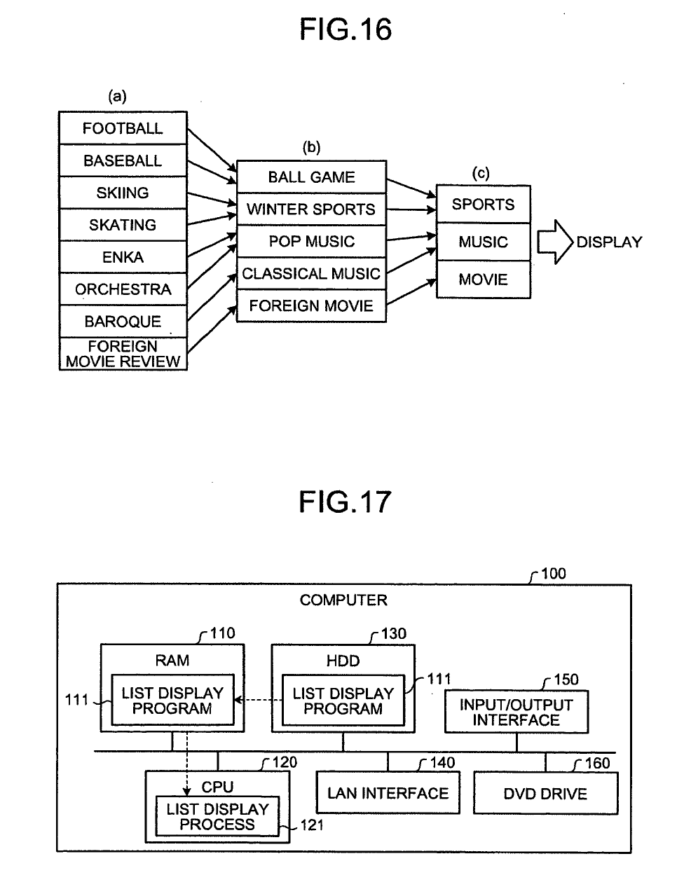

Automatic creation of a category is described below in detail. FIG. 15 depicts an example of a keyword association table used for automatically creating a category. FIG. 16 illustrates automatic creation of a category.

The Web application server 30 may stores therein, for example, a keyword association table as depicted in FIG. 15. In the keyword association table, a plurality of keywords are grouped into groups and stored therein so that the categories that are hierarchized in the groups (a “first association category”, a “second association category”, and a “third association category”) are associated with each other. The first association category is a higher category in which the second association category is summarized. The second association category is a higher category in which the third association category is summarized.

The list creating unit 33e first creates folders that are displayed in the list display area. Then, the list creating unit 33e determines whether the number of the folders is larger than the number of the folders that can be displayed in the list display area.

For example, it is assumed here that three folders can be displayed in the list display area and that the list creating unit 33e creates the folders depicted in (a) of FIG. 16. Then, the number of the folders is eight, and is larger than the number of the folders that can be displayed in the display area that is three. Therefore, the list of the folders cannot be displayed in the display area.

If the list of the folders thus created cannot be displayed in the display area, the list creating unit 33e determines whether a keyword that matches a part or the whole of the category name associated with each folder is registered in the keyword association table in each folder.

If a keyword that matches a part or the whole thereof is registered in the keyword association table, the list creating unit 33e obtains the most subordinate association category (that is, the third category in the example depicted in FIG. 15) associated with the keyword in the keyword association table, and then, replaces the category of the folder with the association category thus obtained as a new category.

On the other hand, if a keyword that matches a part or the whole thereof is not registered in the keyword association table, the list creating unit 33e creates a new category having the category name of “misc”, and replaces the category of the folder with the new category.

The list creating unit 33e performs category replacement in all the folders first created thereby, and then, completes the replacement in all the folders. Then, the list creating unit 33e creates a new folder by summarizing the new categories.

For example, it is assumed here that the list creating unit 33e creates the folders depicted in (b) of FIG. 16. Then, the number of the folders is summarized into five. The number is, however, larger than three. Therefore, the list of the folders cannot be displayed in the display area. Then, the list creating unit 33e replaces the categories according to the keywords as described above, and thus, summarizes the categories.

It is assumed here that the list creating unit 33e creates the folders depicted in (c) of FIG. 16. Then, the number of the folders is summarized into three, and thus, the list can be displayed in the list display area. Therefore, the list creating unit 33e displays the three folders thus created in the display area.

Thus, if the number of the articles in each folder is too large so that the list cannot be displayed in the list display area when the list creating unit 33e creates a list of folders, the categories are automatically summarized, thereby creating a folder having a new category. Therefore, even if the arbitrary categories registered by the user are increased in number, the number of the categories included in the list can be dynamically modified according to the size of the list display area. Therefore, the articles can be conveniently browsed in the list.

(3) List Display Computer Program

In the first embodiment above, the Web application server 30 is described in detail. Configuration of the Web application server 30 may, however, be implemented as software. Then, a list display computer program having the similar functions to the Web application server 30 can be obtained. A computer that executes the list display computer program is described below.

FIG. 17 is a functional block diagram for explaining a configuration of the computer that executes the list display computer program. As depicted in FIG. 17, a computer 100 includes a random access memory (RAM) 110, a central processing unit (CPU) 120, a hard disk drive (HDD) 130, a local area network (LAN) interface 140, an input/output interface 150, and a digital versatile disk (DVD) drive 160.

The RAM 110 is a memory that stores therein computer programs, results of the computer programs while the computer programs are executed, and the like. The CPU 120 is a central processing unit that reads the computer programs in the RAM 110, and executes the computer programs.

The HDD 130 is a disk device that stores therein computer programs and data. The LAN interface 140 is an interface that is used to connect the computer 100 to other computers via a LAN.

The input/output interface 150 is an interface that is used to connect an input device such as a mouse and a keyboard and a display device to the computer 100. The DVD drive 160 is a device that reads and writes data from and to a DVD.

A list display computer program 111 executed by the computer 100 is stored in a DVD, is read from the DVD by using the DVD drive 160, and is installed in the computer 100.

Alternatively, the list display computer program 111 may be stored in, for example, a database in another computer system connected to the computer 100 via the LAN interface 140, may be read from the database, and may be installed in the computer 100.

The list display computer program 111 is stored in the HDD 130, is read therefrom to the RAM 110, and is executed by the CPU 120 as a list display process 121.

In the present embodiment, an example is described in which the present invention is applied to a Web system that provides an SNS service. The present invention is, however, not limited thereto. The present invention may be similarly applied to any Web system having functions by which a list of information is displayed regardless of service provided by the Web system.

In the various processes described in the embodiments, all or a part of processes that are described to be automatically performed may be performed manually. Alternatively, all or a part of processes that are described to be manually performed may be automatically performed in a well-known method.

Information including the processing procedures, the control procedures, the specific names, various data and parameters disclosed in the documents above and the accompanying drawings can be arbitrarily modified unless otherwise indicated.

Respective configuration elements of the respective illustrated devices depicted in the drawings are functionally conceptual and are not always physically configured as illustrated. Specifically, a specific pattern into which the devices are dispersed or integrated is not limited to the illustrated pattern. The devices may be configured by functionally or physically dispersing or integrating all or some of the devices on any unit in accordance with various loads or usages.

All or some of the processing functions performed by the devices may be implemented by a CPU or a computer program that is analyzed and executed by the CPU, or by wired-logic hardware.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A list display method in which a computer displays a list of articles in a predetermined display area of a display device, the list display method comprising:
creating a list of subjects of the articles if the number of articles is equal to or less than a predetermined display number, and creating a list of categories in which the articles are categorized if the number of articles is larger than the display number; and
displaying the created list in the display area.

2. The list display method according to claim 1, further comprising:
obtaining a display size of the display area; and
calculating the display number based on the display size obtained, wherein
the creating includes creating a list of subjects of the articles if the number of articles is equal to or less than the calculated display number, and creating a list of categories in which the articles are categorized if the number of articles is larger than the calculated display number.

3. The list display method according to claim 1, further comprising obtaining category information in which the categories are defined, wherein
the creating includes deleting, from the created list of the categories, the category to which none of the articles belongs based on the category information obtained.

4. The list display method according to claim 1, further comprising:
receiving selection of categories from the list of the displayed categories;
in response to the selection of the categories, creating a list of subjects of the articles if the number of articles that belong to the selected category is equal to or less than a predetermined subordinate display number, and creating a list of subordinate categories in which the articles are categorized if the number of articles is larger than the subordinate display number; and
displaying the created list of subordinate categories in the display area.

5. The list display method according to claim 1, further comprising:
obtaining category summary information in which a plurality of categories and a higher category that summarizes the categories are associated with each other, wherein
the creating includes, upon creating the list of the categories, creating a list of higher categories in which the list of the categories is summarized based on the category summary information obtained if the number of categories in which the articles are categorized is larger than a predetermined summary display number.

6. A list display apparatus comprising:
a display area in which a list of articles is to be displayed;
a list creating unit that creates a list of subjects of the articles if the number of articles is equal to or less than a predetermined display number, and creates a list of categories in which the articles are categorized if the number of articles is larger than the display number; and
a list display unit that displays the created list in the display area.

7. A computer readable storage medium containing instructions for displaying a list of articles in a predetermined display area of a display device, wherein the instructions, when executed by a computer, cause the computer to perform:
creating a list of subjects of the articles if the number of articles is equal to or less than a predetermined display number, and creating a list of categories in which the articles are categorized if the number of articles is larger than the display number; and
displaying the created list in the display area.
